(19) United States
(12) Patent Application Publication
(10) Pub. No.: US 2024/0357594 A1
(43) Pub. Date: Oct. 24, 2024

(54) METHOD PERFORMED BY NETWORK NODE

(71) Applicant: Samsung Electronics Co., Ltd., Suwon-si (KR)

(72) Inventors: Danye WU, Beijing (CN); Yuhan HU, Beijing (CN); Jian YANG, Beijing (CN); Ming JIN, Beijing (CN); Yelong ZHANG, Beijing (CN)

(21) Appl. No.: 18/671,362

(22) Filed: May 22, 2024

Related U.S. Application Data
(63) Continuation of application No. PCT/KR2024/004987, filed on Apr. 12, 2024.

(30) Foreign Application Priority Data
Apr. 14, 2023 (CN) 202310403888.2
Mar. 21, 2024 (CN) 202410330669.0

(51) Int. Cl. H04W 72/20; H04W 72/12; H04W 72/512

(52) U.S. Cl. CPC H04W 72/20; H04W 72/12; H04W 72/512

(57) ABSTRACT

A method performed by a first network node in a communication system for supporting ultra-reliable and low latency communication (URLLC) in open radio access network (O-RAN) is provided. The method includes receiving a control plane message of a first communication from a second network node, wherein the control plane message comprises preemption type information and information related to the first communication preempting resource layers of a second communication, and determining resources for the first communication based on the control plane message.

### CROSS-REFERENCE TO RELATED APPLICATION(S)

This application is a continuation application, claiming priority under § 365 (c), of an International application No. PCT/KR2024/004987, filed on Apr. 12, 2024, which is based on and claims the benefit of a Chinese patent application number 202310403888.2, filed on Apr. 14, 2023, in the Chinese Intellectual Property Office, and of a Chinese patent application number 202410330669.0, filed on Mar. 21, 2024, in the Chinese Intellectual Property Office, the disclosure of each of which is incorporated by reference herein in its entirety.

### TECHNICAL FIELD

The disclosure relates to a communication method. More particularly, the disclosure relates to a method performed by a network node in a communication system.

### BACKGROUND

In order to meet an increasing demand for wireless data communication services since a deployment of 4^{th} generation (4G) communication system, efforts have been made to develop an improved 5^{th} generation (5G) or pre-5G communication system. Therefore, the 5G or pre-5G communication system is also called “beyond 4G network” or “post long-term evolution (LTE) system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

5^{th}-generation, 5^{th} generation mobile communication technology (5G) has been gradually standardized, and its three application scenarios mainly include ultra-reliable and low latency communication (URLLC), enhanced mobile broadband (EMBB) and massive machine type communication (mMTC). However, with the application and development of 5G, more and more devices and mobile data are connected to the 5G system, and the radio access network (RAN) is facing the problems of increasing business volume, huge investment cost and insufficient flexibility. In order to address these issues, operators hope to achieve faster innovation and higher flexibility, reduce equipment costs and achieve higher performance by opening up the standardization of third-party equipment.

In this situation, open radio access network (O-RAN) standard came into being. O-RAN allows network devices from different suppliers to interoperate, and the standardized interface becomes more open and the functions are more flexible. At the same time, the introduction of machine learning and artificial intelligence will bring new opportunities to O-RAN and accelerate the innovation speed. An open and intelligent wireless access network is conducive to reducing equipment costs, stimulating innovation, and promoting the application of various new fields to the market faster.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method performed by a network node in a communication system.

Additional aspects will be set forth in part in the description which follows and, in part, will be apparent from the description, or may be learned by practice of the presented embodiments.

In accordance with an aspect of the disclosure, a method performed by a first network node in a communication system is provided. The method includes receiving a control plane message of a first communication from a second network node, wherein the control plane message includes information related to the first communication preempting resources of a second communication, and determining resources for the first communication based on the control plane message.

In an implementation, the method further includes sending capability information related to the first communication preempting resources of the second communication to the second network node.

In an implementation, sending the capability information related to the first communication preempting resources of the second communication to the second network node includes sending a message about supported section extension to the second network node, wherein the message about section extension includes the capability information related to the first communication preempting resources of the second communication, and sending capability information of supporting second preemption to the second network node. In an implementation, the capability information of supporting second preemption includes three preemption sub-capabilities, a first preemption sub-capability, a second preemption sub-capability, and a third preemption sub-capability. If supporting second preemption sub-capability is sent, a first duration is sent at the same time, if supporting third preemption sub-capability is sent, the first duration and a second duration are simultaneously sent.

In an implementation, the capability information of supporting the first preemption indicates whether the first communication has the capability of preempting the control plane resources of the second communication, the capability information of supporting the second preemption indicates whether the first communication has the capability of preempting the user plane resources of the second communication, the three preemption sub-capabilities indicate three different latest times when the first communication is allowed to preempt the user plane resources of the second communication. In an implementation, the information related to the first communication preempting the resources of the second communication is carried in the section extension of the control plane message.

In an implementation, the information related to the first communication preempting the second communication includes information related to the preemption type of the first communication preempting the second communication and information related to the resource layers of the second communication preempted by the first communication.

In an implementation, the information related to the preemption type of the first communication preempting the second communication includes first preemption, which indicates that the first communication preempts the control plane resources of the second communication, or second preemption, indicating that the first communication preempts the user plane resources of the second communication.

In an implementation, the information related to the resource layers of the second communication preempted by the first communication includes one or more first invalid resource layer identifiers, wherein each of the one or more first invalid resource layer identifiers indicates the resource layers of the second communication preempted by the first communication, or a second invalid resource layer identifier indicating that the first communication preempts the resources of all resource layers of the second communication.

In an implementation, the determining the resources used for the first communication based on the control plane message includes the first preemption marks the control plane information of the resources of the second communication preempted by the first communication as invalid, and the second preemption flushes the user plane data of the second communication preempted by the first communication, and after receiving the user plane message of the first communication, coupling the user plane message with the control plane message, and only coupling using valid control plane information is allowed, but coupling using invalid control plane information is not allowed. In an implementation, the first preemption sub-capability is to support user plane preemption before the user plane data processing of the second communication starts, the second preemption sub-capability is to support user plane preemption before the digital beamforming of the second communication starts, the third preemption sub-capability is to support user plane preemption before Inverse Fast Fourier Transform (IFFT) of the second communication starts.

In an implementation, the first duration is the shortest time required for the first network node to perform coupling, the first duration is the shortest time required for the first network node to perform digital beamforming.

In an implementation, the first network node is an open radio access network radio unit (O-RU), and/or the second network node is an open radio access network distribution unit (O-DU).

In an implementation, the first communication is ultra-reliable low-latency communication (URLLC), and/or the second communication is an enhanced mobile broadband (EMBB).

In accordance with aspect of the disclosure, a method performed by a second network node in a communication system is provided. The method includes determining whether a first communication can preempt a second communication and determining a preemption type, wherein the preemption type includes a first preemption and a second preemption, if the resources corresponding to the second communication can be preempted by the first communication, sending a control plane message of the first communication to the first network node, wherein the control plane message includes preemption type information and information related to the resource layers of the second communication preempted by the first communication, so that the first network node can determine the resources for the first communication based on the control plane message.

In an implementation, the method further includes receiving the capability information related to the first communication preempting the resources of the second communication sent by the first network node,

In an implementation, determining whether the first communication can preempt the second communication includes determining whether to preempt or not based on at least one of interference level information of each resource layer of the second communication on the first communication, capability information related to the first communication preempting the second communication, and time difference information between the first communication and the second communication, and determining the preemption type if it is determined to preempt.

In an implementation, sending the control plane message of the first communication to the first network node includes if preemption is determined, sending the control plane message of the first communication to the first network node, carrying preemption type information and information related to the first communication preempting the resource layers of the second communication.

In an implementation, based on the interference level information of each resource layer of the second communication on the first communication includes determining the interference level of the second communication on the first communication according to the spatial channel correlation information of the second communication and the first communication, and preemption is only needed if the interference level is greater than a given threshold, otherwise, preemption is not needed, and the second communication and the first communication are allowed to be sent on the same resource.

In an implementation, the spatial channel correlation information includes spatial channel correlation information calculated based on Sounding Reference Signal (SRS) of the second communication and the first communication, or spatial channel correlation information calculated based on beam indexes of the second communication and the first communication.

In an implementation, sending the control plane message of the first communication to the first network node based on the capability information related to the first communication preempting the resources of the second communication, includes sending the control plane message of the first communication to the first network node based on the capability information related to the first communication preempting the resources of the second communication and the second network node supporting the capability of section extension related to the first communication.

In an implementation, receiving the capability information related to the first communication preempting the resources of the second communication sent by the first network node includes receiving a message related to supported section extension from the first network node, that is, the capability information of supporting the first preemption, wherein the message related to section extension includes the capability information related to the first communication preempting the resources of the second communication, and receiving capability information of supporting second preemption from the first network node.

In an implementation, the first preemption capability information indicates whether the first communication has the capability of preempting the control plane resources of the second communication, the second preemption capability information indicates whether the first communication has the capability of preempting the user plane resources of the second communication.

In an implementation, the second preemption capability includes three preemption sub-capabilities, a first preemption sub-capability, a second preemption sub-capability, and a third preemption sub-capability. If supporting the second preemption sub-capability is received, the first duration is received at the same time, if supporting the third preemption sub-capability is received, the first duration and the second duration are received at the same time.

In an implementation, the three preemption sub-capabilities indicate three different latest times to allow the first communication to preempt the user plane resources of the second communication, including the first preemption sub-capability indicates that the first network node supports the user plane preemption before the user plane data processing of the second communication starts, the second preemption sub-capability indicates that the first network node supports user plane preemption before the digital beamforming of the second communication starts, the third preemption sub-capability indicates that the first network node supports user plane preemption before the IFFT of the second communication starts.

In an implementation, the first duration is the shortest time required for the first network node to perform coupling, the first duration is the shortest time required for the first network node to perform digital beamforming.

In an implementation, the time difference information between the first communication and the second communication includes, according to the transmission delay between the first node and the second node, and the transmission window and reception window of the first communication and the second communication, determining whether the first network node can have time to receive the preemption message and perform preemption before the end of the preemption window. Includes at least one of whether the control plane message of the second communication has been sent or not when the control plane message of the first communication is sent, whether the user plane message of the second communication has been sent when the control plane message of the first communication is sent, time relationship between the control plane reception window of the first communication and the user plane reception window of the second communication. If the control plane message of the second communication is not sent when the control plane message of the first communication is sent, not sending the control plane message indicating preemption, and the preempted resources in the control plane message of the second communication are cancelled, if the control plane message of the second communication has been sent, determining whether the user plane message of the second communication has been sent. If the user plane message of the second communication is not sent, determining whether the first network node supports the first preemption, and if so, performing the first preemption, the preemption type is the first preemption, for example, the first preemption is the control plane preemption. If the user plane message of the second communication has been sent, determining whether to preempt and the preemption type according to the time relationship between the user plane reception window of the second communication and the control plane reception window of the first communication, including if the end time of the user plane reception window of the second communication is later than the end time of the control plane reception window of the first communication and the first network node supports the first sub-preemption, or if the end time of the user plane reception window of the second communication delaying by the first duration is later than the end time of the control plane reception window of the first communication, and the first network node supports the second sub-preemption, or if the end time of the user plane reception window of the second communication delaying by the first duration plus the second duration is later than the end time of the control plane reception window of the first communication, and the first network node supports the third sub-preemption, performing preemption, and the preemption type is second preemption, for example, user plane preemption. Preemption cannot be performed in any other cases. In an implementation, the preemption type information and the information related to the resource layers of the second communication preempted by the first communication are carried in the section extension of the control plane message.

In an implementation, the first network node is an open radio access network radio unit (O-RU), and/or the second network node is an open radio access network distribution unit (O-DU).

In an implementation, the first communication is an ultra-reliable low-latency communication (URLLC), and/or the second communication is an enhanced mobile broadband (EMBB).

In accordance with aspect of the disclosure, a first network node is provided. The first network node includes a transceiver configured to transmit and/or receive signals, memory storing one or more computer program, and one or more processors communicatively coupled to the transceiver and the memory, wherein the one or more computer programs include computer-executable instructions that, when executed by the one or more processors, cause the first network node to receive a control plane message of a first communication from a second network node, wherein the control plane message comprises preemption type information and information related to the first communication preempting resources of a second communication, and determine preempted resources of the second communication based on the control plane message.

In accordance with aspect of the disclosure, a second network node is provided. The second network node includes a transceiver configured to transmit and/or receive signals, memory storing one or more computer programs, and one or more processors communicatively coupled to the transceiver and the memory, wherein the one or more computer programs include computer-executable instructions that, when executed by the one or more processors, cause the second network node to receive scheduling information of a first communication, and if resources corresponding to the first communication are occupied by a second communication, send a control plane message of the first communication to the first network node, the control plane message includes preemption type information and information related to the first communication preempting resources of the second communication, so that the first network node can determine the resources preempted by the second communication based on the control plane message.

In accordance with aspect of the disclosure, one or more non-transitory computer-readable storage media storing computer-executable instructions that, when executed by one or more processors of a first network node in a communication system, cause the first network node to perform operations are provided. The operations include receiving a control plane message of a first communication from a second network node, wherein the control plane message comprises preemption type information and information related to the first communication preempting resources of a second communication, and determining preempted resources of the second communication based on the control plane message.

In accordance with aspect of the disclosure, a method performed by a first network node in a communication system is provided. The method comprises receiving a control plane message for a first communication from a second network node, wherein the control plane message comprises resource information for indicating resources for a second communication; and identifying that the resources for the second communication are preempted based on the control plane message.

In accordance with aspect of the disclosure, a method performed by a second network node in a communication system is provided. The method comprises transmitting a control plane message for a first communication to a first network node. The control plane message comprises resource information for indicating resources for the second communication. The control message indicates that the resources for the second communication are preempted.

In accordance with aspect of the disclosure, a first network node is provided. The first network node comprises a transceiver configured to transmit and/or receive signals; at least one processor; and memory storing instructions that, when executed by the one or more processors, cause the first network node to receive, through the transceiver, a control plane message for a first communication from a second network node, wherein the control plane message comprises resource information for indicating resources for a second communication; and identify that the resources for the second communication are preempted based on the control plane message.

In accordance with aspect of the disclosure, a second network node is provided. The second network node comprises a transceiver configured to transmit and/or receive signals; at least one processor; and memory storing instructions that, when executed by the one or more processors, cause the second network node to transmit, through the transceiver to, a control plane message for a first communication to a first network node. The control plane message comprises resource information for indicating resources for the second communication. The control message indicates that the resources for the second communication are preempted.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a reference architecture diagram of a base station of an open radio access network (O-RAN) according to an embodiment of the disclosure;

FIG. 2 illustrates a processing flow of sending and receiving uplink and downlink air interface data in an O-RAN according to an embodiment of the disclosure;

FIG. 3 illustrates a schematic diagram of a transport layer structure of a control plane message according to an embodiment of the disclosure;

FIG. 4 illustrates a schematic diagram of a method supporting ultra-reliable and low latency communication (URLLC) implementation according to an embodiment of the disclosure;

FIG. 5 illustrates a schematic diagram of a method supporting URLLC implementation according to an embodiment of the disclosure;

FIG. 6 illustrates a schematic diagram of an aspect of a method supporting URLLC implementation according to an embodiment of the disclosure;

FIG. 7 illustrates a schematic diagram of three different preemption capabilities supporting user plane preemption for URLLC according to an embodiment of the disclosure;

FIG. 8 illustrates a schematic diagram of how to determine whether to perform preemption for URLLC and a preemption type according to an embodiment of the disclosure;

FIG. 9 illustrates a schematic diagram of determining whether to preempt according to an interference level according to an embodiment of the disclosure;

FIG. 10 illustrates a schematic diagram of determining whether to preempt and determining a preemption type according to a transmission window/reception window according to an embodiment of the disclosure;

FIG. 11 illustrates a flowchart of performing preemption according to an embodiment of the disclosure;

FIG. 12 illustrates a schematic diagram of marking preempted control plane information as invalid according to an embodiment of the disclosure;

FIG. 13 illustrates a schematic diagram of preemption time points under three different preemption capabilities of user plane preemption according to an embodiment of the disclosure;

FIG. 14 illustrates a schematic diagram of flushing preempted user plane data according to an embodiment of the disclosure;

FIG. 15 illustrates a flowchart of coupling only valid control plane information according to an embodiment of the disclosure;

FIG. 16 illustrates a schematic diagram of a coupling of a user plane and a control plane for URLLC according to an embodiment of the disclosure;

FIG. 17 illustrates a schematic diagram of an aspect of a method supporting URLLC implementation according to an embodiment of the disclosure; and

FIG. 18 illustrates a simple block diagram of a hardware structure of a communication device according to an embodiment of the disclosure.

The same reference numerals are used to represent the same elements throughout the drawings.

### DETAILED DESCRIPTION

The following description with reference to the accompanying drawings is provided to assist a comprehensive understanding of various embodiments of the disclosure defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventors to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It should be understood that singular forms of “a”, “an” and “the” include plural referents unless the context clearly dictates otherwise. Thus, for example, reference to a “component surface” includes reference to one or more of such surfaces.

The terms “include” or “may include” refer to the existence of a corresponding disclosed function, operation or component that can be used in various embodiments of the disclosure, and do not limit the existence of one or more additional functions, operations or features. In addition, the terms “including” or “having” can be interpreted as indicating certain characteristics, numbers, steps, operations, constituent elements, components or combinations thereof, but should not be interpreted as excluding the possibility of the existence of one or more other characteristics, numbers, steps, operations, constituent elements, components or combinations thereof.

The term “or” used in various embodiments of the disclosure includes any of the listed terms and all combinations thereof. For example, “A or B” may include A, may include B, or may include both A and B.

Unless defined differently, all terms (including technical terms or scientific terms) used in this disclosure have the same meaning as those understood by those skilled in the art in this disclosure. Common terms, as defined in dictionaries, are interpreted as having meanings consistent with the context in the related technical fields, and should not be interpreted in an idealized or overly formal way unless explicitly defined in this disclosure.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

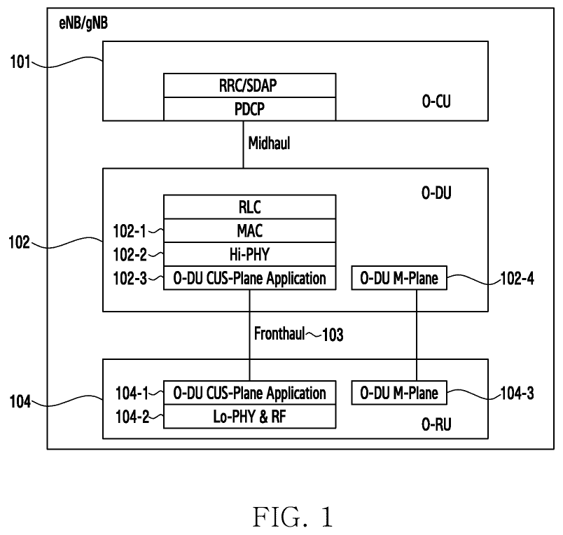

FIGS. 1 to 9 discussed below and various embodiments used to describe the principles of the disclosure in this patent document are for illustration only and should not be interpreted as limiting the scope of the disclosure in any way. Those skilled in the art will understand that the principles of the disclosure can be implemented in any suitably arranged system or device.

Embodiments of the disclosure are further described below with reference to the accompanying drawings.

The text and drawings are provided as examples only to help understand the disclosure. They should not be construed as limiting the scope of the disclosure in any way. Although certain embodiments and examples have been provided, based on the disclosure herein, it is obvious to those skilled in the art that changes can be made to the illustrated embodiments and examples without departing from the scope of this disclosure.

In the basic architecture of O-RAN, the forward haul interface (FH IF) between O-RAN distributed unit (O-DU) and O-RAN radio unit (O-RU) is an open network, which must have strict requirements on transmission delay in limited bandwidth resources, effectively reducing the load of the forward haul interface is also the key content to be considered and optimized in O-RAN. URLLC can effectively support the preemption of resources to achieve high reliability and low delay transmission. However, in the current O-RAN system, there is no in-depth discussion on URLLC, nor does it consider the optimization of FH IF transmission and bandwidth for URLLC. However, due to the delay sensitivity of URLLC, it is necessary to address the issue of resource preemption for URLLC type communication. Under the background of O-RAN, this disclosure proposes a URLLC method, which defines a new FH IF message and corresponding O-DU and O-RU processing procedures, which can effectively improve the efficiency of implementing URLLC in O-RAN.

The gNB/eNB reference architecture of O-RAN is illustrated in FIG. 1. The base station in the figure can support both the next generation nodeB (gNB) base station of 5G new radio (NR) and the evolved nodeB base station of 4G long term evolution (LTE). The reference architectures of gNB and eNB are slightly different, but they have no influence on this disclosure, so no specific distinction is made. The specific modules in the O-RAN reference architecture will be introduced below, and the irrelated modules will not be introduced in detail.

FIG. 1 illustrates a reference architecture diagram of a base station of an O-RAN according to an embodiment of the disclosure.

Referring to FIG. 1, a base station in an O-RAN reference architecture may include the following components:

O-RAN central unit (O-CU) 101, which includes O-RAN central unit-control plane (O-CU-CP) and O-RAN central unit-user plane (O-CU-UP). Among them, O-CU-CP is a logical node including control plane parts of radio resource control (RRC) and packet data convergence protocol (PDCP), and O-CU-UP is a logical node including user plane parts of service data adaptation protocol (SDAP) and PDCP.

O-DU 102 is a logical node based on lower layer functional split, and includes logical nodes of radio link control layer (RLC), media access control layer (MAC) and high physical layer (High-PHY).

The MAC 102-1 is mainly responsible for mapping of logical channels and transport channels, multiplexing MAC service data unit (SDU) from one or more different logical channels onto transport block (TB) for transmission to the physical layer on the transport channel, and demultiplexing the TB transmitted from the physical layer on the transport channel to MAC SDU for one or different logical channels. At the same time, MAC also supports scheduling information reporting, automatic error correction through hybrid automatic repeat request (HARQ) and data transmission according to the priority of logical channels, or the like.

High-PHY 102-2: functions of physical layer processed on the O-DU side of the fronthaul interface, which includes forward error correction coding/decoding, scrambling and modulation/demodulation.

O-DU control, user, synchronization plane application (O-DU CUS-plane application) 102-3: O-DU logic function, O-RAN CUS-plane defines the messages of control-plane (C-plane), user-plane (U-Plane) and -synchronization-plane (S-Plane). Among them, the control plane refers to the real-time control information between O-DU and O-RU, and the control message defines the information, such as scheduling, coordination, etc. needed for data transmission and beamforming. The user plane message carries the In-phase/quadrature (I/Q) data sent between O-DU and O-RU, and the synchronization plane message is responsible for the timing and synchronization between O-DU and O-U.

O-DU management plane (O-DU M-Plane) 102-4: O-DU logic function, involving non-real-time management operation between O-DU and O-RU, which conducts initialization, configuration management, software management, fault management, performance management, file management, or the like, for O-RU, based on network configuration/yet another next generation (NETCONF/YANG).

O-RAN open fronthaul interface (IF) 103: Fronthaul is a logical link connecting O-DU and O-RU, and is responsible for transmitting information of control plane, user plane, synchronization plane and management plane. FH IF includes CUS-Plane interface and M-Plane interface, and is an interface based on enhanced common public radio interface (eCPRI) standard or institute of electrical and electronics engineers (IEEE) 1914.3 standard, and the content transmitted on the interface conforms to O-RAN CUS-Plane standard and M-Plane standard.

O-RAN Radio Unit (O-RU) 104: it is a logical node based on lower layer functional split, which carries low physical layer (Low-PHY) and radio frequency (RF) processing.

O-RU control, user, O-RU control plane/user plane/synchronization plane application (O-RU CUS-plane application) 104-1: O-RU logic function, which is responsible for receiving or sending messages of control plane, user plane and synchronization plane from or to O-DU on the fronthaul interface.

Low-PHY 104-2: Low-PHY refers to the functions processed on the O-RU side of the fronthaul interface after the physical layer of the 3GPP functional layer is split, mainly including digital beamforming, analog beamforming, fast Fourier transform, digital-to-analog conversion and so on.

O-RU management plane (O-RU M-Plane) 104-3: O-RU logic function, which is under the management of O-DU M-Plane, and reports the capabilities to O-DU in the initialization stage, to report which optional capabilities the O-Ru supports.

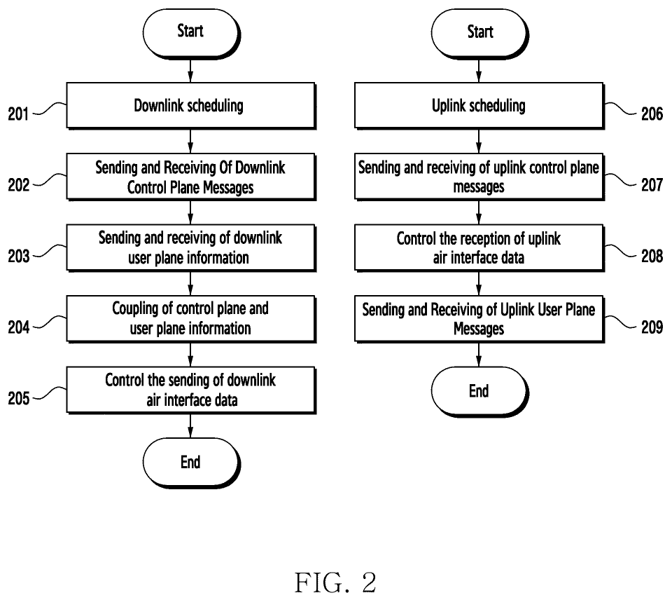

FIGS. 2 to 9 discussed below and various embodiments for describing the principles of the disclosure are for illustration only and should not be construed as limiting the scope of the disclosure in any way. Those skilled in the art will understand that the principles of the disclosure can be implemented in any suitably arranged system or device.

FIG. 2 illustrates a processing flow of sending and receiving uplink and downlink air interface data in an O-RAN according to an embodiment of the disclosure.

Referring to FIG. 2, the method of real-time controlling the sending and receiving of air interface data based on control plane messages. Messages are handled slightly differently for uplink and downlink.

The procedure on the left of FIG. 2 is the processing flow of downlink data, including the following operations:

Operation 201: downlink scheduling, which is performed in MAC scheduler 102-1 of O-DU. After completing the downlink scheduling, the MAC scheduler will send the downlink scheduling result to High-PHY 102-2 for modulation and coding, and also send the scheduling result to O-DU CUS-plane application 102-3 for creating a control plane message and an user plane message. The minimum granularity of the downlink scheduling result in time domain can be, for example, orthogonal frequency division multiplexing symbol (OFDM symbol), and the minimum granularity in frequency domain is resource element (RE), which occupies one OFDM symbol in time domain and one subcarrier in frequency domain). The scheduling result includes, but is not limited to, time and frequency domain resource allocation information of the physical downlink control channel (PDCCH), physical downlink shared channel (PDSCH), channel state information-reference signal (CSI-RS), and beam index.

Operation 202: sending and receiving of downlink control plane messages, which are performed in O-DU and O-RU. The O-DU CUS-plane application 102-3-3 creates a control plane message for controlling the sending of downlink air interface data according to the scheduling result of operation 201, and sends it to the O-RU CUS-plane application 104-1 through FH IF 103. The control plane message mainly indicates information, such as OFDM symbol, (physical resource block (PRB), including REs), RE and beam index, inverse fast Fourier transform (IFFT) parameters, or the like. O-RU CUS-plane application 104-1 receives the control plane message and extracts various field information of the transport layer and the application layer from it.

Operation 203: sending and receiving of downlink user plane messages, which are performed in O-DU and O-RU. O-DU CUS-plane application 102-3 creates the modulated and coded I/Q data output from High-PHY as a downlink user plane message, and send it to O-RU CUS-plane application 104-1 through FH IF 103. The user plane message mainly carries I/Q data carried on each RE in the specified OFDM symbols and PRBs. 104-1 O-RU CUS-plane application receives the user plane message and extracts various field information and I/Q data from it.

Operation 204: coupling of control plane and user plane messages, which is performed in O-DU CUS-plane application 102-3. Because the control plane message and the user plane message are sent separately in the O-RAN CUS-Plane downlink transmission procedure, it is necessary to couple the Section Description in the control plane message with the data section in the user plane message, so that the control plane information can correspond to the user plane information. The basic coupling methods are the coupling based on the section index, in addition, the coupling based on time-frequency domain resources, and the coupling based on time-frequency domain resources with priority.

Operation 205: control the transmission of downlink air interface data. After the O-DU CUS-plane application 102-3 completes the coupling of the control plane message and the user plane message, it delivers the coupled section description and data section to the low-PHY 104-2, which processes the coupled section description and data section, and then performs digital beamforming, iFFT and digital to analog conversion, analog beamforming, or the like, on the downlink data section according to the control information in the section description.

The procedure on the right of FIG. 2 is the processing flow of uplink data, including the following operations:

Operation 206: uplink scheduling, which is performed in MAC scheduler 102-1 of O-DU. Upon completing uplink scheduling, the MAC scheduler will send the uplink scheduling result to High-PHY 102-2 for processing, such as decoding and demodulation, or the like, and also send the scheduling result to O-DU CUS-plane application 102-3 for creating a control plane message. The minimum time granularity of the uplink scheduling result can be, for example, OFDM symbols, and the minimum frequency granularity can be, for example, REs. The scheduling result include but is not limited to time domain and frequency domain resource allocation information of physical uplink control channel (PUCCH), physical uplink shared channel (PUSCH), sounding reference signal (SRS), and beam index, or the like.

Operation 207: sending and receiving of the uplink control plane messages, which are performed in O-DU and O-RU. The O-DU CUS-plane application 102-3 creates a control plane message for controlling the receiving of uplink air interface data according to the scheduling result of operation 206, and sends it to the O-RU CUS-plane application 104-1 through FH IF 103. The control plane message mainly indicates information, such as OFDM symbols, PRBs, REs and beam indexes, fast Fourier transform (FFT) parameters, or the like. O-RU CUS-plane application 104-1 receives the control plane message and extracts various field information of the transport layer and the application layer from it.

Operation 208: control the reception of uplink air interface data, which is performed in O-RU. O-RU CUS-plane application 104-1 indicates the control information carried by the section description extracted from the control plane message to low-PHY 104-2, and the low-PHY performs analog beamforming, FFT and digital beamforming on the uplink air interface data according to the control information, and then delivers the processed I/Q data to O-RU CUS-plane application 104.

Operation 209: sending and receiving of uplink user plane messages, which are performed in O-DU and O-RU. O-RU CUS-plane application 104-1 creates the I/Q data output from Low-PHY as an uplink user plane message, and sends it to O-DU CUS-plane application 102-3 through FH IF 103. This user plane message mainly carries the I/Q data carried on each RE in the specified OFDM symbols and PRBs. O-DU CUS-plane application 102-3 receives the user plane message, extracts I/Q data carried on each RE in the specified OFDM symbols and PRBs, and then delivers the I/Q data to High-PHY for subsequent decoding and demodulation.

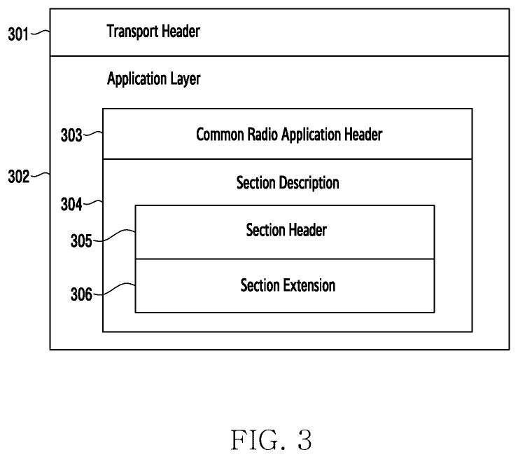

FIG. 3 illustrates a schematic diagram of a transport layer structure of a control plane message according to an embodiment of the disclosure.

Referring to FIG. 3, each control plane message belongs to an endpoint (low-level-tx-endpoint, low-level-rx-endpoint), and each endpoint is configured with a unique extended antenna-carrier identifier (eAxC ID), which presents in the transport layer headers of a control plane message and a user plane message and is used for O-DU and O-RU to distinguish which endpoint the message belongs to. eAxC Id can be divided into ecpriRtcid and ecpriPcid, in which real time control data identifier (ecpriRtcid) is used to identify data streams related to control plane messages. The structure of the transport layer in the control plane message structure is illustrated in FIG. 3:

Transport header 301: consists of an eCPRI common header or an IEEE 1914.3 common header, and includes a corresponding field for indicating the message type.

Application layer 302: includes necessary fields for control and synchronization.

Common radio application header 303: includes information, such as dataDirection, payloadVersion, filterIndex, frame number (frameId), subframe number (subframe), slot number (slotID), start symbol ID, numberOfsections and SectionType.

Section description 304: describes the control information, and a control plane message can contain multiple section descriptions.

Section header 305: contains information, such as section index (sectionId), symbol increment flag (symInc), starting PRB of section description (startPrbc), number of consecutive PRBs in section description (numPrbc), number of symbols (numSymobol) and extension identifier (ef).

Section extension 306: describes the control information except the information contained in the section header, and a section description can contain multiple section extensions. If the value of the extension identifier ef is 1, it means that there are other section extensions following this section extension.

In O-RAN, there is no clearly defined method to support the implementation of URLLC, so the implementation process of URLLC is complicated, and there are mainly the following two alternative implementation methods:
1. Implementing URLLC by reserving PRB resources on OFDM symbols.
2. Implementing URLLC by sending control plane and user plane messages one OFDM symbol by one OFDM symbol to improve the granularity of sending message.

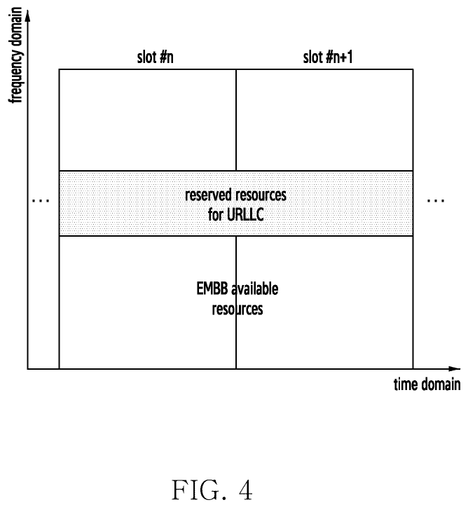

FIG. 4 illustrates a schematic diagram of a method supporting URLLC implementation according to an embodiment of the disclosure.

Referring to FIG. 4, method 1 is a static resource allocation method. As illustrated in FIG. 4, URLLC is implemented by reserving PRB resources on OFDM symbols in advance, and EMBB cannot use PRB resources reserved for URLLC in advance. This method cannot well judge the size of the resources reserved in advance. If the reserved resources are too few, the delay of URLLC will increase and the response speed will be affected. If the reserved resources are too many, the reserved resources will not be fully and reasonably utilized, resulting in a waste of resources, and at the same time, the throughput will be reduced, and the user experience of other non-URLLC will be poor.

Method 2 implements URLLC by sending control plane messages one OFDM symbol by one OFDM symbol.

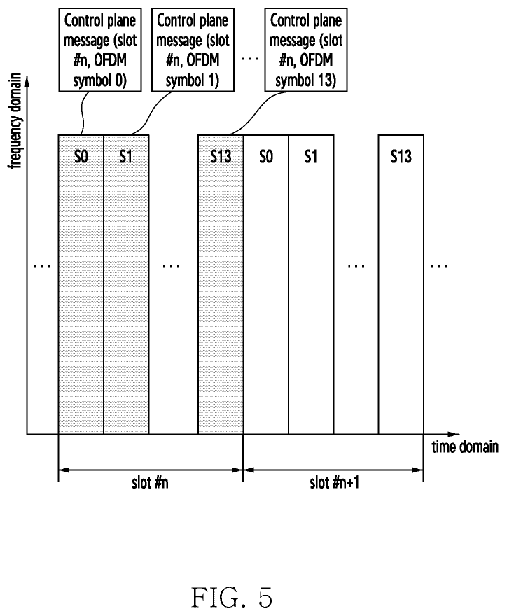

FIG. 5 illustrates a schematic diagram of a method supporting URLLC implementation according to an embodiment of the disclosure.

Referring to FIG. 5, increasing the granularity of sending message can better respond to URLLC requirements, but it will increase the number of control plane messages. Correspondingly, the transport layer header, general radio application header and section header of control plane messages will be repeatedly sent, resulting in a waste of bandwidth resources. In addition, the total number of messages sent per slot increases, which may require additional O-RU capability support. The capability of O-RU to process resources has a certain limit to the maximum number of messages that can be processed in each slot. Please refer to the management plane parameter max-sections-per-slot. Therefore, when a large number of messages arrive at the O-RU within a slot, it may exceed the capacity of the O-RU and require additional support. In addition, URLLC usually has a larger subcarrier spacing than EMBB, that is, the time of an OFDM symbol of URLLC is shorter, so when sending the control plane message of URLLC, the control plane message or user plane message of EMBB may have been sent to O-RU, in which case even if the control plane message is sent one OFDM symbol by one OFDM symbol, URLLC cannot be effectively supported.

In order to better save bandwidth resources and utilize resources, and support the larger subcarrier spacing of URLLC than EMBB, this disclosure proposes a method to support URLLC in O-RAN, which indicates the resources that URLLC needs to be preempted or cancelled in advance by defining a new FH IF message structure. After receiving related messages, the O-RU invalidates the control plane message of the corresponding RE/PRB resources, or flushes the user plane message of the corresponding RE/PRB resources, according to the mark, that is, these resources can only be reserved for the URLLC, and in the subsequent process of coupling the control plane message and the user plane message for EMBB, the user plane message will choose to couple with the valid REs/PRBs instead of the resources reserved for the URLLC through invalidation. This method can avoid sending control plane messages one OFDM symbol by one OFDM symbol, and can also avoid reserving the resources of URLLC, effectively reducing the message load on the fronthaul interface, improving the utilization of resources, and support URLLC with maximum efficiency.

The disclosure also provides a method for O-DU to determine whether preemption can be performed and determine the preemption type. When determining whether to perform preemption, O-DU only preempts EMBB users with high interference and does not preempt EMBB users with low interference, according to the interference level of EMBB on URLLC, thus improving the throughput of EMBB users. In addition, O-DU determines whether to preempt and the type of preemption according to whether the control plane message and user plane message of EMBB are sent when the control plane message of URLLC is sent, so that it can support that URLLC has a larger subcarrier spacing than EMBB, and ensure that there will be no inconsistency between O-DU and O-RU in understanding whether to preempt, thus avoiding the situation that both URLLC and EMBB have decoding errors due to interference when URLLC and EMBB of large interference are sent on the same time-frequency resources. In addition, O-DU determines whether to preempt according to different latest preemption times supported by O-RUs with different capabilities, so that O-RUs with high processing capacity can further reduce the delay of URLLC.

In addition, although the following description mainly takes URLLC to preempt the resources of EMBB as an example, it can be understood that the method and technical principles of the disclosure can also be similarly applied to other communication types, for example, the first type of communication preempts the resources of the second type of communication, the first type of communication can be but not limited to URLLC and the second type of communication can be but not limited to EMBB communication.

Text and drawings are provided as examples only to help readers understand the disclosure. They are not intended and should not be construed to limit the scope of the disclosure in any way. Although certain embodiments and examples have been provided, based on the disclosure herein, it is obvious to those skilled in the art that changes can be made to the illustrated embodiments and examples without departing from the scope of this disclosure.

According to the direction of control plane messages and air interface data, the embodiments of the disclosure can be divided into two categories, one is downlink preemption embodiment, which is denoted as Class A; one is the uplink cancellation embodiment, which is denoted as class B. Therefore, the description of this disclosure lists two embodiments as examples, which are divided into:

Embodiment A: Method for implementing O-RAN downlink PDSCH preemption design through URLLC control information.

Embodiment B: Method for implementing the design of O-RAN uplink PUSCH cancellation through URLLC control information.

It should be understood that although the embodiments are described as Embodiment A and Embodiment B, these two embodiments can be implemented independently, in combination or in part.

Not limited to the above two embodiments, any case that uses or combines the related innovations of this disclosure belongs to the protection scope of this disclosure statement.

Embodiment A: Method for implementing O-RAN downlink PDSCH preemption design through URLLC control information.

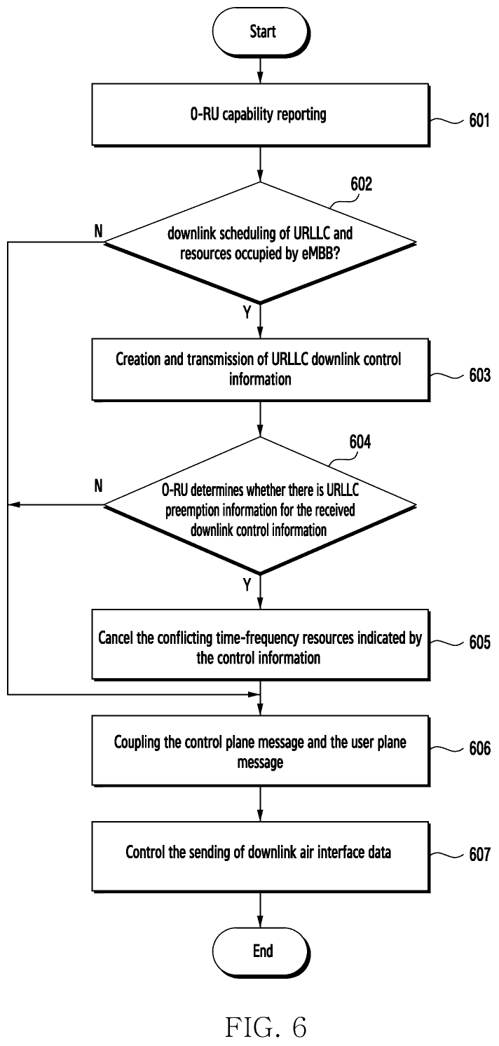

FIG. 6 illustrates a schematic diagram of an aspect of a method supporting URLLC implementation according to an embodiment of the disclosure.

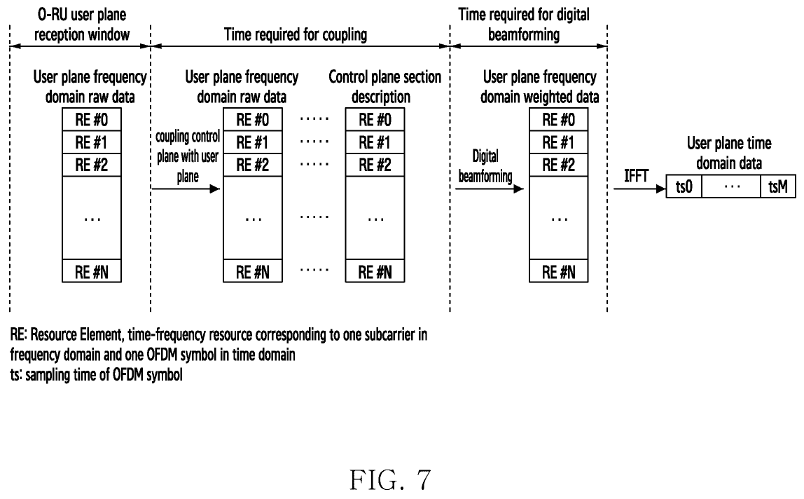

FIG. 7 illustrates a schematic diagram of three different preemption capabilities supporting user plane preemption for URLLC according to an embodiment of the disclosure.

The overall process of embodiment a is illustrated in FIG. 6.

Referring to FIGS. 6 and 7, operation 601 is the process in which O-RU reports URLLC preemption capability to O-DU, which is carried out in the management plane of O-RU and O-DU. By adding URLLC section extension to the section extension list supported-section-extensions in the management plane, it is implemented to support URLLC preemption capability. Specifically, O-RU can report its supported extensions to O-DU through the section extension list supported-section-extensions. If O-RU supports the section extension, it will report the capability as true to O-DU. Specifically, O-RU includes the URLLC section extension type in the supported-section-extensions. The disclosure defines (or describes) the section extension of URLLC as the first interface, which can be a section extension for preempting or cancelling control information, and can be used for, but not limited to, preempting the transmission or cancelling the reception of EMBB by URLLC. If the capability reported by O-RU does not include the first interface, it is considered that O-RU does not support this interface, so it does not support the preemption and cancellation of the URLLC control plane. When the O-DU receives the report by the O-RU, if the report by O-RU carries the first interface, the O-DU can enable the control information preemption or cancellation in the URLLC preemption module. Otherwise, it will not enable the control information preemption or cancellation in the URLLC preemption module. In addition, enabling the URLLC preemption module can also involve adding three kinds of capabilities and/or parameters of supporting user plane preemption in the O-RU capabilities and/or parameters of the management plane, including the capability to support user plane preemption before user plane data processing begins; the capability to support user plane preemption before digital beamforming starts and optionally the shortest time required to perform coupling; the capability to support user plane preemption before IFFT starts and optionally also includes the shortest time required to perform coupling and the shortest time required to perform digital beamforming. These three preemption capabilities and corresponding parameters are illustrated in FIG. 7. If O-RU does not report any of the three capabilities and parameters, it means that O-RU does not support user plane preemption. If O-DU does not support URLLC, O-DU can ignore the capability of preempting URLLC of O-RU for backward compatibility.

Operation 602 is the process of URLLC scheduling, which is carried out in O-DU. URLLC can preempt the resources of EMBB to achieve smaller transmission delay. If there is URLLC scheduling, and the required resources have been occupied by EMBB service and need to be preempted, the following operations will be continued. If there is no URLLC scheduling, or there is no need to preempt resources, operations 603 to 605 can be directly ignored and the process jumps directly to operation 606 to perform normal procedure of data transmission.

Specifically, for EMBB users, MAC needs to avoid occupied resources when scheduling resources (that is, these resources are not associated with any sectionID being used). For URLLC users, when the URLLC preemption module is not enabled, its processing is similar to EMBB. When the URLLC preemption module is enabled, the scheduling resources of URLLC does not need to consider whether the resources have been occupied, but directly allocates them according to the algorithm, and then:
1. If the resources of URLLC have been occupied by EMBB, proceed to operation 603.
2. If the resources of URLLC are not occupied by EMBB, directly create and send the corresponding control plane message.

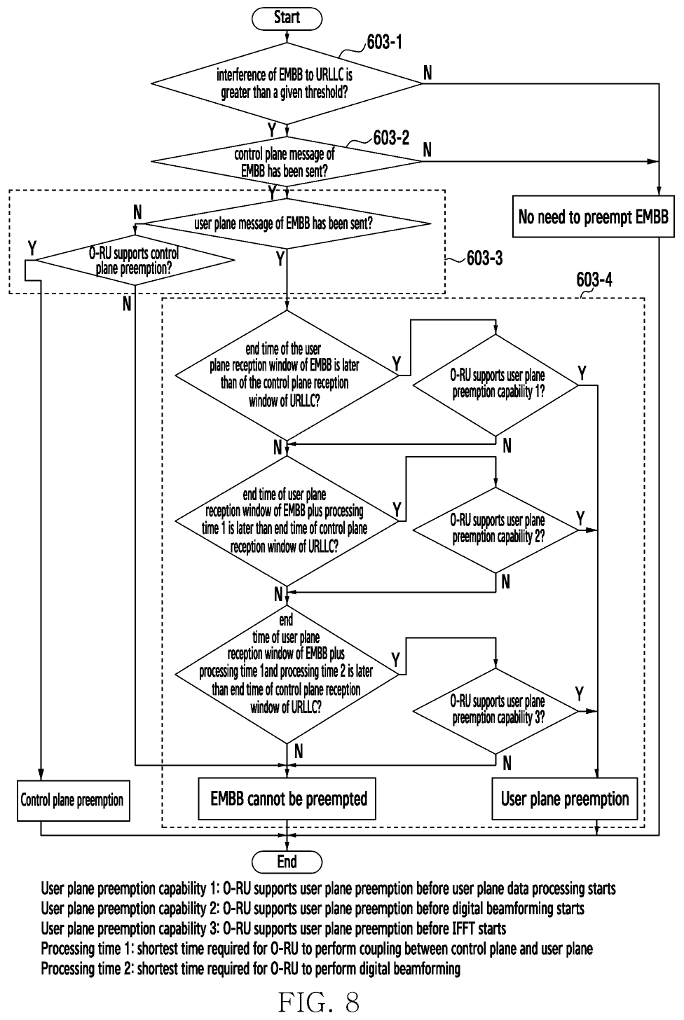

FIG. 8 illustrates a schematic diagram of how to determine whether to perform preemption for URLLC and a preemption type according to an embodiment of the disclosure.

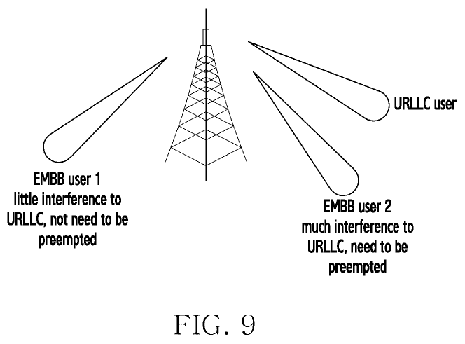

FIG. 9 illustrates a schematic diagram of determining whether to preempt according to an interference level according to an embodiment of the disclosure.

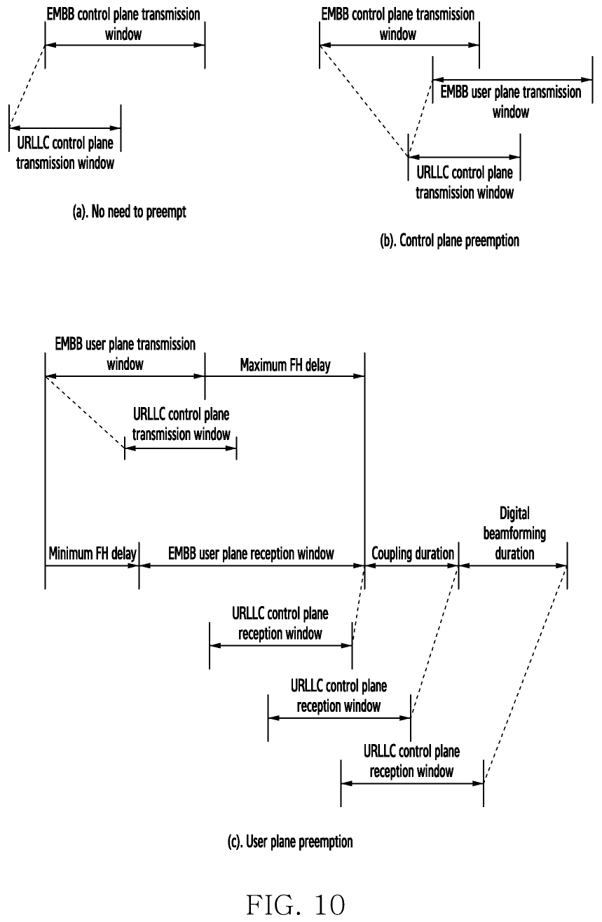

FIG. 10 illustrates a schematic diagram of determining whether to preempt and determining a preemption type according to a transmission window/reception window according to an embodiment of the disclosure.

Referring to FIGS. 8, 9, and 10, operation 603 is to determine whether URLLC is to preempt and the preemption type, and to create and send URLLC preemption messages. This process is carried out in O-DU, and the procedure is as illustrated in FIG. 8. At least one of operations 603-1, 603-2, 603-3, and 603-4 in FIG. 8 is optional. The specific procedure is as follows:
1. Obtain the channel correlation information of EMBB and URLLC according to SRS or beam index, and determine the interference level of EMBB on URLLC. If the interference level is less than a given threshold, there is no need to preempt, that is, EMBB and URLLC are allowed to transmit on the same resources; otherwise, preemption is needed and the next operation is performed. As illustrated in FIG. 9.
2. Check whether the control plane message of EMBB has been sent when the control plane message of URLLC is sent. If the start time of the control plane transmission window of URLLC is later than that of EMBB, the control plane message of EMBB has been sent when the control plane message of URLLC is sent. If not sent, there is no need to send a control plane message indicating preemption, and the preempted resources in the control plane message of EMBB are cancelled, as illustrated in part (a) of FIG. 10, if sent, proceed to the next operation.
3. Check whether the user plane message of EMBB has been sent when the control plane message of URLLC is sent. If the start time of the control plane transmission window of URLLC is later than the start time of the user plane transmission window of EMBB, the user plane message of EMBB has been sent when the control plane message of URLLC is sent. If not sent, determine whether the O-RU supports control plane preemption, and if it does, perform preemption, and the preemption type is control plane preemption, as illustrated in part (b) of FIG. 10; if sent, proceed to the next operation.
4. Check the time relationship between the user plane reception window of EMBB and the control plane reception window of URLLC to determine whether to preempt the user plane. If any of the following conditions are met, perform preemption, and the preemption type is user plane preemption, as illustrated in part (c) of FIG. 10.
4.1. The end time of the user plane reception window of EMBB is later than that of the control plane reception window of URLLC, and O-RU supports user plane preemption before user plane data processing begins;
4.2. The end time of the user plane reception window of EMBB delaying by the shortest time required for coupling is later than the end time of the control plane reception window of URLLC, and O-RU supports user plane preemption before digital beamforming begins;
4.3. The end time of the user plane reception window of EMBB delaying by the shortest time required for coupling plus the shortest time required for digital beamforming is later than the end time of the control plane reception window of URLLC, and O-RU supports user plane preemption before IFFT;
5. Set the preemption of EMBB that needs to be preempted on different layers to the same preemption type. Traverse all EMBB users that need to be preempted:
5.1. If the preemption result of the EMMB user is unable to preempt, the final preemption result is preemption failure, and the traversal ends;
5.2. If the preemption result of EMMB user is control plane preemption, and the final preemption result is not user plane preemption, mark the final preemption state as control plane preemption, and record the ecpriRitcid of this EMBB user;
5.3. If the preemption result of the EMMB user is user plane preemption, mark the final preemption state as user plane preemption, and record the ecpriRitcid of the EMBB user;

If the final preemption state in the above operations is control plane preemption or user plane preemption, creating and sending the preemption information. The process of creating and sending section description in control plane information is consistent with that described in O-RAN WG4 CUS-Plane, and the newly added section extension structure for indicating preemption can be defined as follows according to Table 1:

TABLE 1
newly-added section extension structure

| | | | |
|---|---|---|---|
| ef | extType = xx | 1 | Octet N |

| extLen (variable) | | 1 | N + 1 |
|---|---|---|---|
| preemptType | numEcpriRtcid | 1 | N + 2 |

| | | |
|---|---|---|
| invalid_ecpriRtcid_1 | 2 | N + 3 |
| invalid_ecpriRtcid_2 | 2 | N + 5 |
| . . . | | |
| invalid_ecpriRtcid_M | 2 | variable |
| zero pad to 4-byte boundary | var | variable |

The meaning and filling instructions of each field of URLLC extension structure are as follows:

extension flag (ef) occupies 1 bit, indicating the extension identifier. When ef=1, it means that there presents other section extensions following this section extension. When ef=0, it means that this extension is the last section extension. Accordingly, if the section extension presents, the ef in its previous section description or section extension should be identified as 1.

extension type (extType) occupies 7 bits, indicating the extension type. For the extension type of the newly added section extension, a specific value can be used to indicate it, for example, it can be indicated by forcibly filling the extension type extType as the number xx, where xx is a value indicating the type of the newly added section extension, which can be a numerical value, for example.

extension length (extLen) occupies 8 bits, the size of the extension structure, indicates how many 32-bits or 4-bytes the whole extension occupies.

preemption type (preemptType): occupies 1 bit or 2 bits, which is used to indicate the preemption type. A value of 0 indicates control plane preemption, and a value of 1 indicates user plane preemption. When it occupies 1 bit, the first bit in the significant bits of the current byte is a reserved field.

number of invalid_ecpriRitcids (numEcpriRtcid): occupies 6 bits, which is used to indicate how many ecpriRitcids identified as invalid are included in the section extension. The range of values is 0000000b-111111b, which can cover up to 64 ecpriRitcids.

Invalid_ecpriRtcid_i (i=1, 2, . . . , M): occupies 16 bits, which is used to indicate that O-DU decides to preempt the resources of different layers of MU-MIMO or different spatial layers of SU-MIMO to transmit URLLC information. The ecpriRtcid of the created control plane message may or may not be included in invalid_ecprirtcid_i (i=1, 2, . . . , M), where M represents the number of resource layers to be preempted and M=numEcpriRtcid.

Especially, in order to distinguish different ecpriRtcids indicated by Invalid_ecpriRtcid_i (i=1, 2, . . . , M), the values of Invalid_ecpriRtcid_i should be sorted from small to large. In an implementation, only one Invalid_ecpriRtcid may be used to indicate the resources that the O-DU decides to preempt, for example, it can be achieved by setting invalid_ecpriRtcid to a specific value. For example, if the first value is Invalid_ecpriRtcid_1=0x0000, it means that the section extension of the URLLC needs to preempt all ecpriRtcids in the slot (or related time unit), and at this time, numEcpriRtcid=1, extLen=2.

zero pad to 4-byte boundary: bits for padding zeros, and its function is to make the number of bytes occupied by section extension consistent with the number of bytes defined by extLen.

When resource preemption is needed for URLLC, it is necessary to add this extension to the section description involved in URLLC preemption in the control message, in which the filling of extType is fixed. The value of ef needs to be determined according to whether there are other section extensions following. The value of extLen needs to be determined according to the number M of Invalid_ecpriRtcids, and its value is the ceiling of (M*2+3)/4. If (M*2+3) % 4!=0, zero pad is needed to make up the position, so that the size of the extension is consistent with that defined by extLen.

Specifically, for each user plane message, if there are preempted resources in the message, the part of time-frequency resources preempted are identified by the sectionId in the URLLC user plane message, while the un-preempted time-frequency resources are still identified by the sectionId in the original EMBB control plane message.

Invalid_ecpriRtcid_i indicates the ecpriRtcid that needs to be invalidated, which corresponds to the index of a preempted layer. When the preempted resources are for multi-user multiple-input multiple-output (MU-MIMO), the preempted resources come from different layers of multiple users.

When a URLLC preempts resources, it may happen that multiple URLLCs preempt the same block of resources. When a resource block has been preempted by a URLLC, it cannot be preempted by other URLLC users again, that is, the ecpriRcid of each layer should not be included in the Invalid_ecpriRtcid_i (i=1, 2, . . . , M) of section extension of other layers.

Specifically, in a slot, if there are two URLLCs, both need to preempt eMMB resources, and the eMMB resources to be preempted by the two URLLCs are the same. At this time, only one URLLC is allowed to preempt the resources, and the other is not allowed to occupy the same. For the sake of simplicity, the first-come-first-served method is adopted here. The URLLC user who comes first occupies the resources, but the user who comes later cannot occupy the resources and can postpone sending or consider occupying other resources.

Operation 604 is the receiving process of URLLC control information, which is carried out in O-RU. The O-RU parses the received control information and identifies whether it contains the section extension of URLLC according to extType. If the section extension for preemption by URLLC is contained, proceed to the next operation. If the section extension for preemption by URLLC is not contained, directly ignore the operation 605 and go to operation 606 for the normal process of coupling user plane messages and control plane messages.

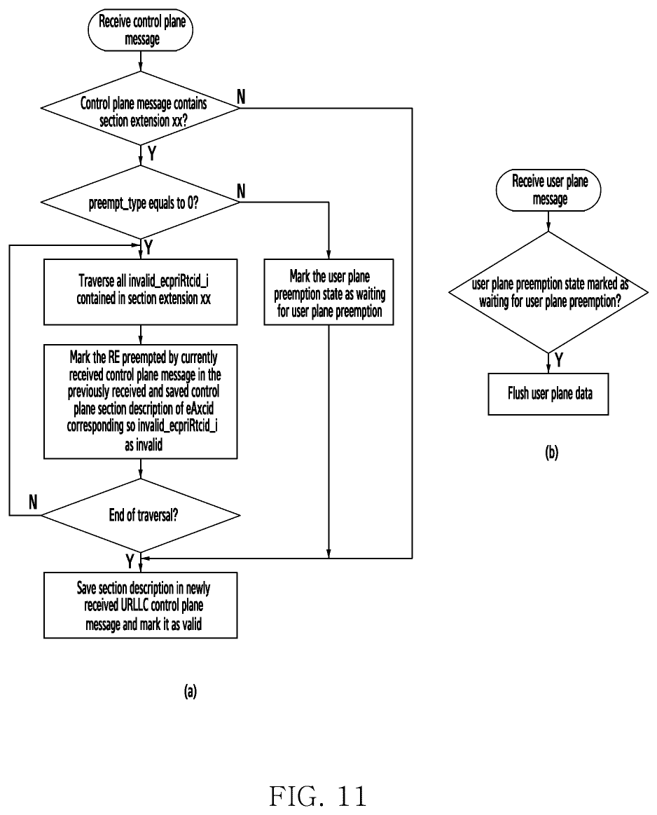

FIG. 11 illustrates a flowchart of performing preemption according to an embodiment of the disclosure.

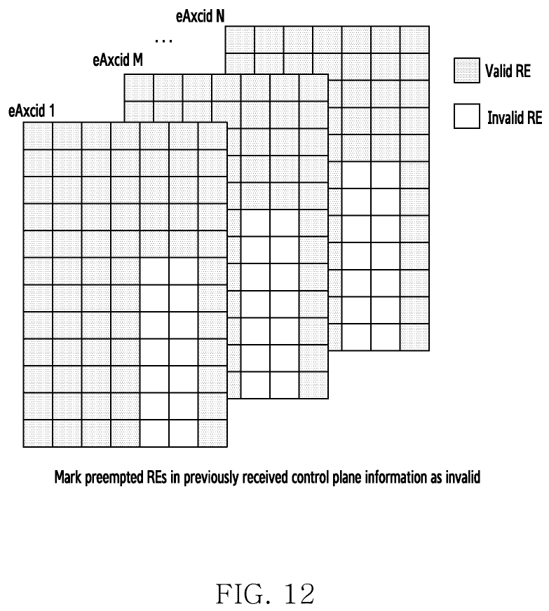

FIG. 12 illustrates a schematic diagram of marking preempted control plane information as invalid according to an embodiment of the disclosure.

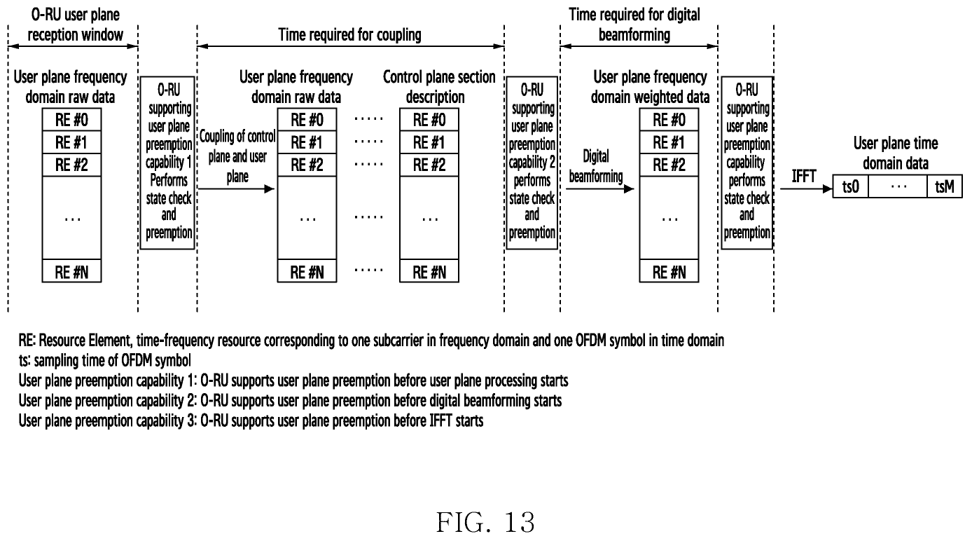

FIG. 13 illustrates a schematic diagram of preemption time points under three different preemption capabilities of user plane preemption according to an embodiment of the disclosure.

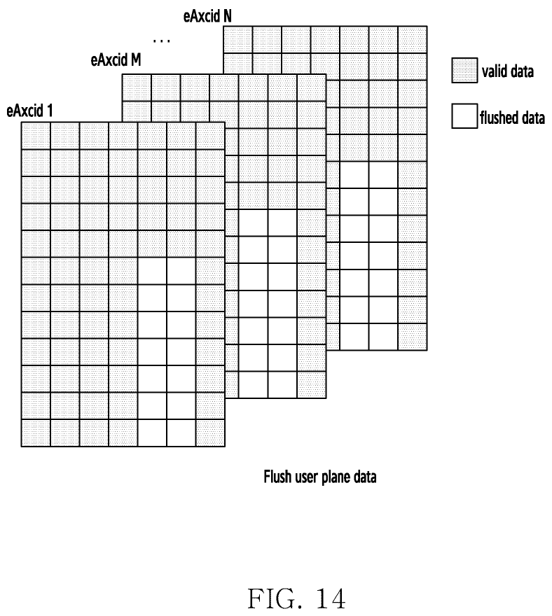

FIG. 14 illustrates a schematic diagram of flushing preempted user plane data according to an embodiment of the disclosure.

Referring to FIGS. 11, 12, 13, and 14, in operation 605, O-RU marks the control plane information on resources of conflict location of EMBB as invalid or flushes the user plane data according to the preemption message indicated in the received URLLC section extension, as illustrated in FIG. 11. Part (a) of FIG. 11 illustrates the procedure of processing control plane information, in which the REs preempted by the current control plane message among the REs of EMBB are marked as invalid, part (b) of FIG. 11 illustrates the procedure of processing the user plane data, in which the user plane data of which the user plane preemption state is marked as waiting for user plane preemption is flushed, and the user plane preemption state is marked as waiting for the user plane preemption according to the preemption type in the section extension in the control plane processing procedure in part (a) of FIG. 11.

After receiving the control plane message containing URLLC extension, O-RU reads each section description and section extension of the control plane, and the processing of URLLC section extension is included in the process.

It is determined whether each section description carries the URLLC section extension. If the section description carried in the control plane message does not carry the URLLC section extension, the processing is consistent with the existing processing; otherwise, it means that URLLC preemption exists, and the processing is as follows:
1. O-RU retrieves the section descriptions carrying URLLC section extension in all control plane messages, and determines the time-frequency resources used by URLLC according to the time-frequency resources indicated in each section description (determined by parameters, such as startPrbc, numPrbc, startSymbolId and numSymbol).
2. O-RU processes the Invalid_ecpriRtcid_i in the URLLC section extension in this section description one by one. For an ecpriRtcid indicated by a certain Invalid_ecpriRtcid_i, the overlapping part with the time-frequency resources in the URLLC control information under this Id is deducted, that is, the section of time-frequency resources originally allocated to EMBB users with the ecpriRtcid become idle resources. Especially, when Invalid_ecpriRtcid is 0x0000, it means that all layers are processed. At this time, all layers need to be traversed, and the part of resources in each layer overlapping with URLLC is deducted. The deduction includes: if the preemption type is control plane preemption, marking the control plane message of the corresponding resources as invalid, as illustrated in FIG. 12, if the preemption type is user plane preemption, the current user plane preemption state is marked as waiting for user plane preemption.
3. For O-RU supporting different user plane preemption sub-capabilities, check the current user plane preemption state at the following three time points, as illustrated in FIG. 13. If the current user plane preemption state is waiting for user plane preemption, perform user plane preemption, and the user plane data of the corresponding resources is flushed, as illustrated in FIG. 14.
3.1. For O-RU that supports user plane preemption before user plane data processing starts, check the current user plane preemption state before user plane data processing starts, and if it is waiting for user plane preemption, then perform user plane preemption.
3.2. For O-RU that supports user plane preemption before digital beamforming starts, check the current user plane preemption state before digital beamforming starts, and if it is waiting for user plane preemption, perform user plane preemption.
3.3. For O-RU that supports user plane preemption before IFFT starts, check the current user plane preemption state before digital IFFT starts, and if it is waiting for user plane preemption, perform user plane preemption.

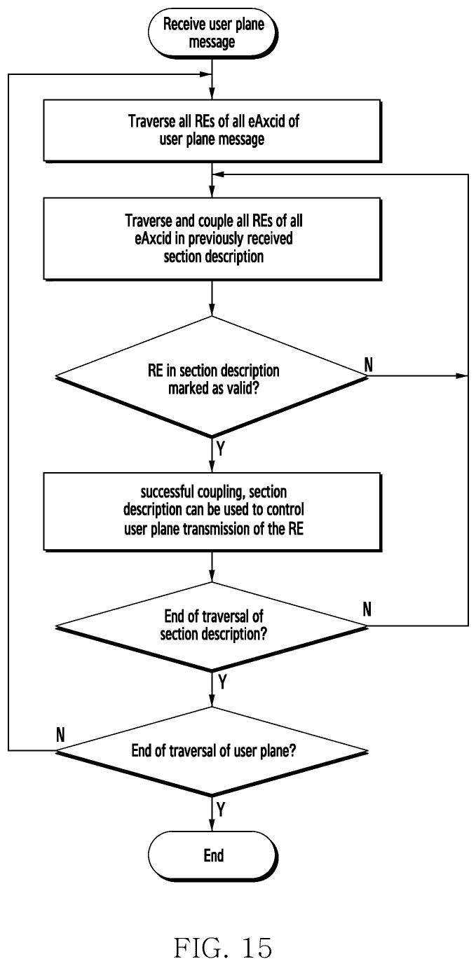

FIG. 15 illustrates a flowchart of coupling only valid control plane information according to an embodiment of the disclosure.

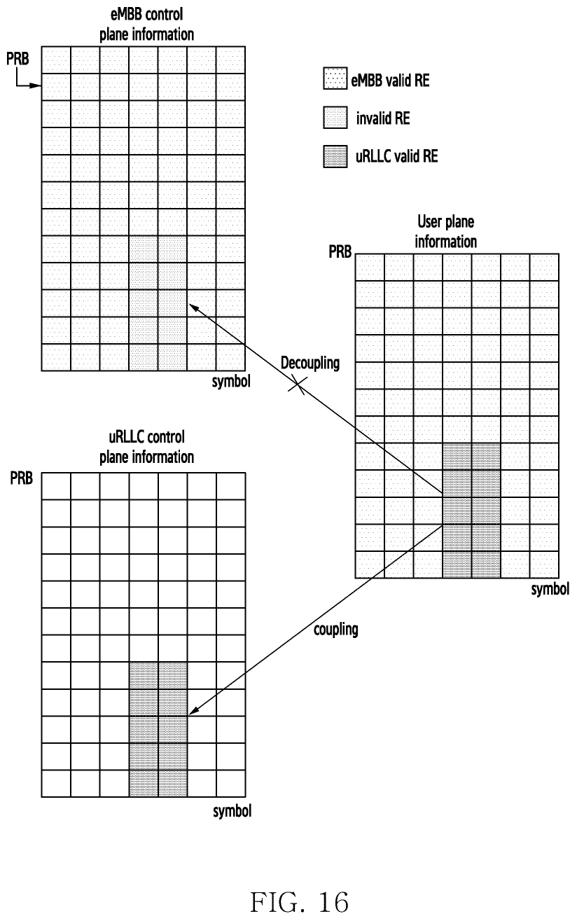

FIG. 16 illustrates a schematic diagram of a coupling of a user plane and a control plane for URLLC according to an embodiment of the disclosure.

Referring to FIGS. 15 and 16, operation 606 is a process in which O-RU re-couples the user plane message and the control plane message of URLLC, do not coupling using the invalid control plane information, but only do coupling using the valid control plane information. The preemption of EMBB resources in operation 605, marks the preempted control plane information as invalid, and makes the occupied resources become idle again. Operation 606 allocates the preempted resources to URLLC, as illustrated in FIG. 15. REs for EMBB will be coupled with control plane information of EMBB only when they are marked as valid in the section description. If REs for EMBB is marked as invalid in the section description in URLLC, the process goes to the traversal of RE, that is, skipping the coupling between the REs and control plane information of EMBB, so that only valid control plane information is coupled. The idle resource block in each Invalid_ecpriRtcid_i in the URLLC extension in the section description is allocated to the URLLC, and then the resources of this section is processed according to the section description in the URLLC, as illustrated in FIG. 16. Especially, when Invalid_ecpriRtcid is 0x0000, it means that all layers are processed. At this time, all layers need to be traversed, and the overlapping part of resources of each layer with URLLC needs to be preempted.

The control plane message of URLLC can be coupled with the corresponding user plane message. After processing the data, the transmission of data can be proceeded. So far, the O-RAN downlink PDSCH preemption based on URLLC has been completed.

Operation 607 is the control of transmission of downlink air interface data, after coupling the URLLC control plane message and the user plane message, O-DU delivers the coupled section description and data section to Low-PHY, and the Low-PHY processes the coupled section description and data section, and then performs digital beamforming, iFFT, digital-to-analog conversion and analog beamforming on the downlink data section according to the control information in the section description.

Embodiment B: Method for implementing the design of O-RAN uplink PUSCH cancellation through URLLC control information.

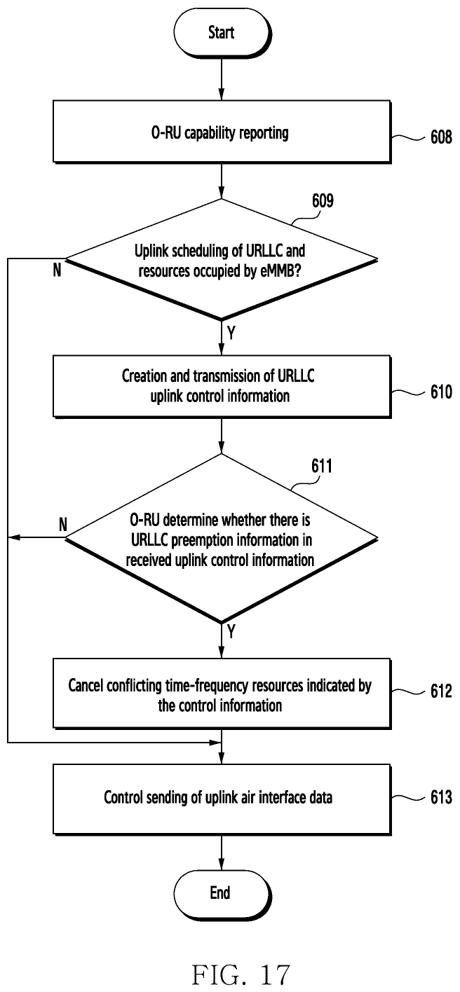

FIG. 17 illustrates a schematic flow chart of embodiment B according to an embodiment of the disclosure.

Referring to FIG. 17, operation 608 is the process of O-RU reporting URLLC preemption capability to O-DU, which is consistent with the operation described in operation 601.

Operation 609 is the process of uplink URLLC scheduling, which is carried out in O-DU. RLLC can preempt the resources of EMBB to achieve a smaller transmission delay. If there is scheduling of URLLC, and the required resources have been occupied by EMBB traffic, the subsequent operations need to be preempted. If there is no scheduling of URLLC, or there is no need to preempt resources, the subsequent operation can be directly ignored.

Operation 610 is the creation and sending of URLLC uplink control message, which is carried out in O-DU, and the creation of URLLC section extension is consistent with the process described in operation 603. When preemption is required, O-DU needs to add this extension to the control plane message preempted by URLLC, and fill up the remaining fields of URLLC section extension according to the location where resources need to be preempted, and send it to O-RU.

Operation 611 is the process of receiving the uplink control information of URLLC, which is carried out in O-RU. The O-RU parses the received control information and identifies whether it contains the section extension of URLLC according to the extType. If it contains the section extension for URLLC preemption, proceed to the next operation. If it does not contain the section extension for URLLC preemption, the operation 612 is directly ignored and the normal process of data transmission is completed in operation 613.

Operation 612 is to invalidate the resources indicated by the URLLC control information.

After receiving the control plane message containing URLLC extension, O-RU reads each section description and section extension in the control plane, and the processing of URLLC section extension is included in the process.

Determine whether each section description carries the URLLC section extension. If the section description carried in the control plane message does not carry the URLLC section extension, it is consistent with the existing process, otherwise, it means that URLLC preemption presents, and the processing is as follows:
1. O-RU retrieves the section descriptions carrying URLLC section extension in all control plane messages, and determines the time-frequency resources to be used by URLLC according to the time-frequency resources indicated in each section description (determined by parameters, such as startPrbc, numPrbc, startSymbolId and numSymbol).
2. O-RU processes the Invalid_ecpriRtcid_i in the URLLC section extension in the section description one by one, and for a given ecpriRtcid, the part of time-frequency resources overlapping with the URLLC control information under this Id is deducted, that is, the section of time-frequency resources originally allocated by the ecpriRtcid to EMBB users becomes idle resources.

After canceling the time-frequency resources used by EMBB, the uplink PUSCH cancellation of O-RAN based on URLLC has been completed.

Operation 613 is to control the sending of the uplink user plane message. O-RU uses the original resources released by the EMBB to be idle to create the URLLC user plane data as an uplink user plane message and send it to O-DU through FH I/F.

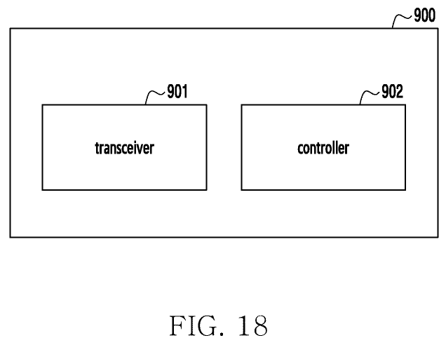

FIG. 18 illustrates a simple block diagram of a hardware structure of a communication device according to an embodiment of the disclosure.

Referring to FIG. 18, a communication device 900 can be used to implement any method according to the principles of the disclosure. Therefore, it can be understood that the communication device 900 may be, for example, the aforementioned O-RU or O-DU, or may be any network node for implementing the method of the disclosure.

Referring to FIG. 18, a communication device 900 according to an embodiment of the disclosure includes a transceiver 901 and a controller 902. Optionally, the communication device 900 may further include memory (not shown). The transceiver 901 can transmit signals or data, or receive signals or data. The controller 902 may be coupled with the transceiver 901 and the memory, and control the operations of the transceiver 901 and the memory. Computer executable instructions are stored in the memory, which, when performed by the controller 902, cause at least one method corresponding to the above embodiments of the disclosure to be executed. The above is only an embodiment of the disclosure, and it is not used to limit the disclosure. Any modification, equivalent substitution, improvement, etc. made within the spirit and principle of the disclosure should be included in the scope of protection of the disclosure.

In embodiments, a method performed by a first network node in a communication system is provided. The method comprises receiving a control plane message of a first communication from a second network node, wherein the control plane message comprises preemption type information and information related to the first communication preempting resources of a second communication; and determining preempted resources of the second communication based on the control plane message.

For example, the determining of the preempted resources of the second communication based on the control plane message comprises based on the preemption type information, performing first preemption or second preemption on the resources corresponding to the information related to the first communication preempting resources of a second communication. The first preemption marks control plane information of resources of the second communication preempted by the first communication as invalid. The second preemption flushes user plane data of the second communication preempted by the first communication.

For example, the control plane information marked as invalid is not used for coupling with user plane information.

For example, the method further comprises sending capability information related to the first communication preempting the resources of the second communication to the second network node. The capability information includes information about at least one of a first preemption capability supporting first preemption and a second preemption capability supporting second preemption.

For example, the second preemption capability comprises at least one of a first preemption sub-capability, a second preemption sub-capability and a third preemption sub-capability. The first preemption sub-capability indicates that user plane preemption is supported before the coupling of user plane information and control plane information of the second communication. The second preemption sub-capability indicates that user plane preemption is supported before beamforming of the second communication. For example, the third preemption sub-capability indicates that user plane preemption is supported before inverse fast Fourier transform of the second communication.

For example, the information about the second preemption sub-capability further includes information about a first duration required for the first network node to perform coupling of control plane information and user plane information. The information about the third preemption sub-capability also includes information about the first duration and information about a second duration required for the first network node to perform beamforming.

For example, the information related to the first communication preempting the resources of the second communication and preemption type are carried in section extension of the control plane message.

For example, the information related to the first communication preempting the resources of the second communication comprises information related to the first communication preempting resource layers of the second communication.

For example, the information related to the first communication preempting the resource layers of the second communication comprises one or more first invalid resource layer identifiers. Each of the one or more first invalid resource layer identifiers indicates a resource layer of the second communication preempted by the first communication, or a second invalid resource layer identifier indicating that the first communication preempts the resources of all resource layers of the second communication.

For example, the first network node is an open radio access network radio unit open radio access network radio unit (O-RU). The second network node is an open radio access network distribution unit open radio access network distribution unit (O-DU).

For example, the first communication is an ultra-reliable low-latency communication (URLLC). The second communication is enhanced mobile broadband (EMBB).

In embodiments, a method performed by a second network node in a communication system is provided. The method comprises receiving scheduling information of a first communication; and if resources corresponding to the first communication are occupied by a second communication, sending a control plane message of the first communication to a first network node. The control plane message includes preemption type information and information related to the first communication preempting resources of the second communication, so that the first network node can determine the resources preempted by the second communication based on the control plane message.

For example, the method comprises determining whether the first communication preempts the resources of the second communication based on time difference information that the first communication and the second communication are expected to arrive at the first network node; and if it is determined that the first communication preempts the resources of the second communication, the control plane message is sent to the first network node.

For example, the determining of whether the first communication preempts the resources of the second communication based on the time difference information that the first communication and the second communication are expected to arrive at the first network node comprises determining whether the first communication preempts the resources of the second communication based on transmission delay between the first network node and the second network node, transmission window and/or reception window of the first communication and the second communication.

For example, the method comprises receiving capability information about the first communication preempting the resources of the second communication sent by the first network node. The capability information includes information about at least one of a first preemption capability supporting first preemption and a second preemption capability supporting second preemption. Preemption type is determined as one of first preemption or second preemption based on the capability information and a first time.

For example, the second preemption capability comprises at least one of a first preemption sub-capability, a second preemption sub-capability and a third preemption sub-capability. The first preemption sub-capability indicates that user plane preemption is supported before coupling of user plane information and control plane information of the second communication. The second preemption sub-capability indicates that user plane preemption is supported before beamforming of the second communication. The third preemption sub-capability indicates that user plane preemption is supported before Inverse Fast Fourier Transform of the second communication.

For example, the information about the second preemption sub-capability further includes information about a first duration required for the first network node to perform coupling of control plane information and user plane information. The information about the third preemption sub-capability also includes information about the first duration and information about a second duration required for the first network node to perform beamforming.

For example, the information about the first communication preempting the resources of the second communication is carried in a section extension of the control plane message. The section extension includes information indicating preemption type.

For example, the method comprises determining an interference level between the first communication and the second communication; and based on the interference level, determining the resources of the second communication to be preempted by the first communication.

For example, the first network node is an open radio access network radio unit open radio access network radio unit (O-RU). The second network node is an open radio access network distribution unit open radio access network distribution unit (O-DU).

For example, the first communication is an ultra-reliable low-latency communication (URLLC). The second communication is enhanced mobile broadband (EMBB).

In embodiments, a first network node is provided. The first network node comprises a transceiver configured to transmit and/or receive signals; memory storing one or more computer programs; and one or more processors communicatively coupled to the transceiver and the memory. The one or more computer programs include computer-executable instructions that, when executed by the one or more processors, cause the first network node to receive a control plane message of a first communication from a second network node, wherein the control plane message comprises preemption type information and information related to the first communication preempting resources of a second communication, and determine preempted resources of the second communication based on the control plane message.

In embodiments, a second network node is provided. The second network node comprises a transceiver configured to transmit and/or receive signals; memory storing one or more computer programs; and one or more processors communicatively coupled to the transceiver and the memory. The one or more computer programs include computer-executable instructions that, when executed by the one or more processors, cause the second network node to receive scheduling information of a first communication, and if resources corresponding to the first communication are occupied by a second communication, send a control plane message of the first communication to a first network node, the control plane message includes preemption type information and information related to the first communication preempting resources of the second communication, so that the first network node can determine the resources preempted by the second communication based on the control plane message.

In embodiments, one or more non-transitory computer-readable storage media storing computer-executable instructions that, when executed by one or more processors of a first network node in a communication system, cause the first network node to perform operations is provided. The operations comprise receiving a control plane message of a first communication from a second network node, wherein the control plane message comprises preemption type information and information related to the first communication preempting resources of a second communication; and determining preempted resources of the second communication based on the control plane message.

In embodiments, a method performed by a first network node in a communication system is provided. The method comprises receiving a control plane message for a first communication from a second network node, wherein the control plane message comprises resource information for indicating resources for a second communication; and identifying that the resources for the second communication are preempted based on the control plane message.

For example, the method comprises performing first preemption or second preemption on the resources corresponding to the information related to the first communication preempting resources of a second communication. The control message includes preemption type information for indicating the first preemption or the second preemption. The first preemption is used to mark control plane information for the second communication as invalid. The second preemption is used to flush user plane data for the second communication preempted by the first communication.

For example, the control plane information marked as invalid is not used for coupling with user plane information.

For example, the method comprises transmitting capability information to the second network node. The capability information includes information related to at least one of a first preemption capability for the first preemption or a second preemption capability for the second preemption.

For example, the second preemption capability comprises at least one of a first preemption sub-capability, a second preemption sub-capability or a third preemption sub-capability. The first preemption sub-capability indicates that user plane preemption is supported before the coupling of user plane information and control plane information. The second preemption sub-capability indicates that user plane preemption is supported before beamforming. The third preemption sub-capability indicates that user plane preemption is supported before inverse fast Fourier transform.

For example, the resource information and the preemption type are carried in section extension of the control plane message.

For example, the resource information includes one or more invalid resource layer identifiers. Each of the one or more invalid resource layer identifiers indicates a resource layer for the second communication preempted by the first communication.

For example, the first network node comprises an open radio access network radio unit open radio access network radio unit (O-RU). The second network node comprises an open radio access network distribution unit open radio access network distribution unit (O-DU). The first communication comprises an ultra-reliable low-latency communication (URLLC). The second communication comprises enhanced mobile broadband (EMBB).

In embodiments, a method performed by a second network node in a communication system is provided. The method comprises transmitting a control plane message for a first communication to a first network node. The control plane message comprises resource information for indicating resources for the second communication. The control message indicates that the resources for the second communication are preempted.

For example, the control message includes preemption type information for indicating the first preemption or the second preemption. The first preemption is used to mark control plane information for the second communication as invalid. The second preemption is used to flush user plane data for the second communication preempted by the first communication.

For example, the control plane information marked as invalid is not used for coupling with user plane information.

For example, the method comprises receiving capability information from the first network node. The capability information includes information related to at least one of a first preemption capability for the first preemption and a second preemption capability for the second preemption.

For example, the second preemption capability comprises at least one of a first preemption sub-capability, a second preemption sub-capability or a third preemption sub-capability. The first preemption sub-capability indicates that user plane preemption is supported before coupling of user plane information and control plane information. The second preemption sub-capability indicates that user plane preemption is supported before beamforming. The third preemption sub-capability indicates that user plane preemption is supported before Inverse Fast Fourier Transform.

For example, the resource information and the preemption type are carried in a section extension of the control plane message.

For example, the resource information includes one or more invalid resource layer identifiers. Each of the one or more invalid resource layer identifiers indicates a resource layer for the second communication preempted by the first communication.

For example, the first network node is an open radio access network radio unit open radio access network radio unit (O-RU). The second network node is an open radio access network distribution unit open radio access network distribution unit (O-DU). The first communication is an ultra-reliable low-latency communication (URLLC). The second communication is enhanced mobile broadband (EMBB).

In embodiments, a first network node is provided. The first network node comprises a transceiver configured to transmit and/or receive signals; at least one processor; and memory storing instructions that, when executed by the one or more processors, cause the first network node to receive, through the transceiver, a control plane message for a first communication from a second network node, wherein the control plane message comprises resource information for indicating resources for a second communication; and identify that the resources for the second communication are preempted based on the control plane message.

For example, the resource information includes one or more invalid resource layer identifiers. Each of the one or more invalid resource layer identifiers indicates a resource layer for the second communication preempted by the first communication. The first network node comprises an open radio access network radio unit open radio access network radio unit (O-RU). The second network node comprises an open radio access network distribution unit open radio access network distribution unit (O-DU). The first communication comprises an ultra-reliable low-latency communication (URLLC). The second communication comprises enhanced mobile broadband (EMBB).

In embodiments, a second network node is provided. The second network node comprises a transceiver configured to transmit and/or receive signals; at least one processor; and memory storing instructions that, when executed by the one or more processors, cause the second network node to transmit, through the transceiver to, a control plane message for a first communication to a first network node. The control plane message comprises resource information for indicating resources for the second communication. The control message indicates that the resources for the second communication are preempted.

For example, the resource information includes one or more invalid resource layer identifiers. Each of the one or more invalid resource layer identifiers indicates a resource layer for the second communication preempted by the first communication. The first network node comprises an open radio access network radio unit open radio access network radio unit (O-RU). The second network node comprises an open radio access network distribution unit open radio access network distribution unit (O-DU). The first communication comprises an ultra-reliable low-latency communication (URLLC). The second communication comprises enhanced mobile broadband (EMBB).

It will be understood by those skilled in the art that this application may include devices for performing one or more of the operations described in this application. These devices can be specially designed and manufactured for required purposes, or they can also include known devices in general-purpose computers. These devices have computer programs stored therein, which are selectively activated or reconfigured. Such a computer program may be stored in a device (e.g., a computer) readable medium including but not limited to any type of disk (including floppy disk, hard disk, optical disk, compact disc read only memory (CD-ROM), and magneto-optical disk), read-only memory (ROM), random access memory (RAM), erasable programmable read-only memory (EPROM), electrically erasable programmable read-only memory (EEPROM), flash memory, magnetic card or optical card. For example, a readable medium includes any medium in which information is stored or sent by a device (e.g., a computer) in a readable form.

It will be understood by those skilled in the art that each block in these structural diagrams and/or block diagrams and/or flow diagrams and combinations of blocks in these structural diagrams and/or block diagrams and/or flow diagrams can be implemented by computer program instructions. It can be understood by those skilled in the art that these computer program instructions can be provided to a general-purpose computer, a professional computer or a processor of other programmable data processing methods for implementation, so that the scheme specified in the block or blocks of the structure diagram and/or block diagram and/or flow diagram disclosed in the disclosure can be performed by the processor of the computer or other programmable data processing methods.

Those skilled in the art can understand that the operations, measures and schemes in various operations, methods and processes discussed in the disclosure can be alternated, modified, combined or deleted. Further, other operations, measures and schemes in the various operations, methods and processes already discussed in the disclosure can also be alternated, changed, rearranged, decomposed, combined or deleted. Further, operations, measures and schemes in various operations, methods and flows disclosed in the disclosure in the prior art can also be alternated, changed, rearranged, decomposed, combined or deleted.

What the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means”.

What is claimed is:

1. A method performed by a first network node in a communication system, the method comprising:
receiving a control plane message for a first communication from a second network node, wherein the control plane message comprises resource information for indicating resources for a second communication; and
identifying that the resources for the second communication are preempted based on the control plane message.

2. The method of claim 1,
performing first preemption or second preemption on the resources corresponding to the information related to the first communication preempting resources of a second communication,
wherein the control message includes preemption type information for indicating the first preemption or the second preemption,
wherein the first preemption is used to mark control plane information for the second communication as invalid, and
wherein the second preemption is used to flush user plane data for the second communication preempted by the first communication.

3. The method of claim 2, wherein the control plane information marked as invalid is not used for coupling with user plane information.

4. The method of claim 2, further comprising:
transmitting capability information to the second network node,
wherein the capability information includes information related to at least one of a first preemption capability for the first preemption or a second preemption capability for the second preemption.

5. The method of claim 4,
wherein the second preemption capability comprises at least one of a first preemption sub-capability, a second preemption sub-capability or a third preemption sub-capability,
wherein the first preemption sub-capability indicates that user plane preemption is supported before the coupling of user plane information and control plane information,
wherein the second preemption sub-capability indicates that user plane preemption is supported before beamforming, and
wherein the third preemption sub-capability indicates that user plane preemption is supported before inverse fast Fourier transform.

6. The method of claim 2, wherein the resource information and the preemption type are carried in section extension of the control plane message.

7. The method of claim 1,
wherein the resource information includes one or more invalid resource layer identifiers, and
wherein each of the one or more invalid resource layer identifiers indicates a resource layer for the second communication preempted by the first communication.

8. The method of claim 1,
wherein the first network node comprises an open radio access network radio unit open radio access network radio unit (O-RU),
wherein the second network node comprises an open radio access network distribution unit open radio access network distribution unit (O-DU),
wherein the first communication comprises an ultra-reliable low-latency communication (URLLC), and
wherein the second communication comprises enhanced mobile broadband (EMBB).

9. A method performed by a second network node in a communication system, the method comprising:
transmitting a control plane message for a first communication to a first network node,
wherein the control plane message comprises resource information for indicating resources for the second communication, and
wherein the control message indicates that the resources for the second communication are preempted.

10. The method of claim 9,
wherein the control message includes preemption type information for indicating the first preemption or the second preemption,
wherein the first preemption is used to mark control plane information for the second communication as invalid, and
wherein the second preemption is used to flush user plane data for the second communication preempted by the first communication.

11. The method of claim 10, wherein the control plane information marked as invalid is not used for coupling with user plane information.

12. The method of claim 10, further comprising:
receiving capability information from the first network node,
wherein the capability information includes information related to at least one of a first preemption capability for the first preemption and a second preemption capability for the second preemption.

13. The method of claim 12,
wherein the second preemption capability comprises at least one of a first preemption sub-capability, a second preemption sub-capability or a third preemption sub-capability,
wherein the first preemption sub-capability indicates that user plane preemption is supported before coupling of user plane information and control plane information,
wherein the second preemption sub-capability indicates that user plane preemption is supported before beamforming, and
wherein the third preemption sub-capability indicates that user plane preemption is supported before Inverse Fast Fourier Transform.

14. The method of claim 10,
wherein the resource information and the preemption type are carried in a section extension of the control plane message.

15. The method of claim 9,
wherein the resource information includes one or more invalid resource layer identifiers, and
wherein each of the one or more invalid resource layer identifiers indicates a resource layer for the second communication preempted by the first communication.

16. The method of claim 9,
wherein the first network node is an open radio access network radio unit open radio access network radio unit (O-RU),
wherein the second network node is an open radio access network distribution unit open radio access network distribution unit (O-DU),
wherein the first communication is an ultra-reliable low-latency communication (URLLC), and
wherein the second communication is enhanced mobile broadband (EMBB).

17. A first network node comprising:
a transceiver configured to transmit and/or receive signals;
at least one processor; and
memory storing instructions that, when executed by the one or more processors, cause the first network node to:
receive, through the transceiver, a control plane message for a first communication from a second network node, wherein the control plane message comprises resource information for indicating resources for a second communication; and
identify that the resources for the second communication are preempted based on the control plane message.

18. The first network node of claim 17,
wherein the resource information includes one or more invalid resource layer identifiers,
wherein each of the one or more invalid resource layer identifiers indicates a resource layer for the second communication preempted by the first communication,
wherein the first network node comprises an open radio access network radio unit open radio access network radio unit (O-RU),
wherein the second network node comprises an open radio access network distribution unit open radio access network distribution unit (O-DU),
wherein the first communication comprises an ultra-reliable low-latency communication (URLLC), and
wherein the second communication comprises enhanced mobile broadband (EMBB).

19. A second network node comprising:
a transceiver configured to transmit and/or receive signals;
at least one processor; and
memory storing instructions that, when executed by the one or more processors, cause the second network node to:
transmit, through the transceiver to, a control plane message for a first communication to a first network node,
wherein the control plane message comprises resource information for indicating resources for the second communication, and
wherein the control message indicates that the resources for the second communication are preempted.

20. The second network node of claim 19,
wherein the resource information includes one or more invalid resource layer identifiers,
wherein each of the one or more invalid resource layer identifiers indicates a resource layer for the second communication preempted by the first communication,
wherein the first network node comprises an open radio access network radio unit open radio access network radio unit (O-RU),
wherein the second network node comprises an open radio access network distribution unit open radio access network distribution unit (O-DU),
wherein the first communication comprises an ultra-reliable low-latency communication (URLLC), and
wherein the second communication comprises enhanced mobile broadband (EMBB).
